(19) United States
(12) Patent Application Publication
(10) Pub. No.: US 2017/0144295 A1
(43) Pub. Date: May 25, 2017

(54) TOOL HOLDER

(71) Applicant: Yu-Hua OU, Taichung City (TW)

(72) Inventor: Yu-Hua OU, Taichung City (TW)

(21) Appl. No.: 14/950,743

(22) Filed: Nov. 24, 2015

(51) Int. Cl. B25H 3/00

(52) U.S. Cl. CPC B25H 3/003

(57) ABSTRACT

A tool holder is provided for at least one universal joint to be assembled thereto, the universal joint includes a plug and a socket which are movable relative to each other, and the tool holder includes a main body and a positioning member. The main body includes a hanging portion and an assembling portion, and the assembling portion is protrudingly formed with at least one first engaging block. The positioning member is assembled to the main body and extends toward the assembling portion to form at least one second engaging block opposite to the at least one first engaging block, wherein the at least one first engaging block and the at least one second engaging block are for being fitted and engaged with the plug and the socket of the universal joint.

### BACKGROUND OF THE INVENTION

Field of the Invention

The present invention relates to a tool holder, and more particularly to an anti-theft tool holder.

Description of the Prior Art

Usually, when a universal joint is in storage or put on shelves, the universal joint is engaged with a holder, and then, the holder is placed on the wall or the display board. A conventional universal joint has two joints and a connecting member connected with and pivoted to the two joints. The conventional holder has a main body, a side of the main body is protrudingly formed with an engaging block, the engaging block is engaged with one end of the joint, the other end of the joint abuts against a lateral wall of the other side of the main body so as to connect the universal joint and the holder together. The above-mentioned holder is disclosed in TWM454912.

The conventional holder can be engaged with the universal joint and can be hung on the wall. However, the two joints are pivoted to the connecting member, so if the two joints swing relative to each other, a straight distance between two ends of the universal joint becomes shorter, one of the joint cannot abut against a lateral wall of one side of the main body, and the other joint can be disengaged with the engaging block. Hence, the conventional holder does not have an anti-theft function, and the universal joint may be easily stolen when being put on shelves.

The present invention has arisen to mitigate and/or obviate the afore-described disadvantages.

### SUMMARY OF THE INVENTION

The major object of the present invention is to provide a tool holder for a universal joint to be assembled thereto so as to prevent the universal joint from being disengaged with the tool holder. Therefore, the tool holder is anti-theft.

To achieve the above and other objects, a tool holder is provided for at least one universal joint to be assembled thereto, the universal joint includes a plug and a socket which are movable relative to each other, and the tool holder includes a main body and a positioning member. The main body includes a hanging portion and an assembling portion, and the assembling portion is protrudingly formed with at least one first engaging block. The positioning member is assembled to the main body and extends toward the assembling portion to form at least one second engaging block which is opposite to the at least one first engaging block, wherein the at least one first engaging block and the at least one second engaging block are for being fitted and engaged with the plug and the socket of the universal joint.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of a preferred embodiment of the present invention;

FIGS. 2 and 3 are breakdown views of the preferred embodiment of the present invention;

FIG. 4 is a perspective view of another preferred embodiment of the present invention; and

FIGS. 5 and 6 are breakdown views of another preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

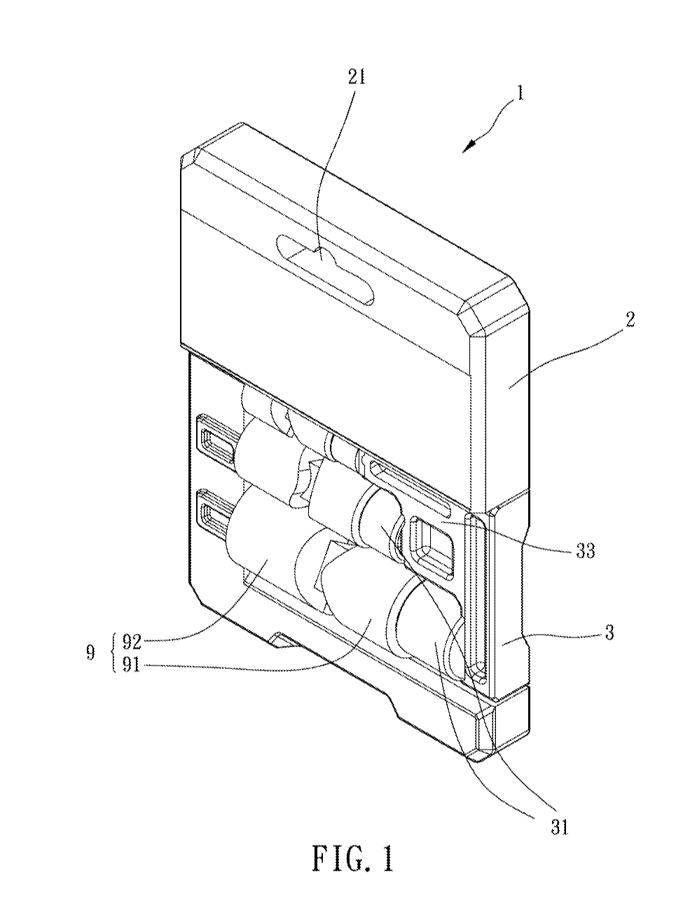

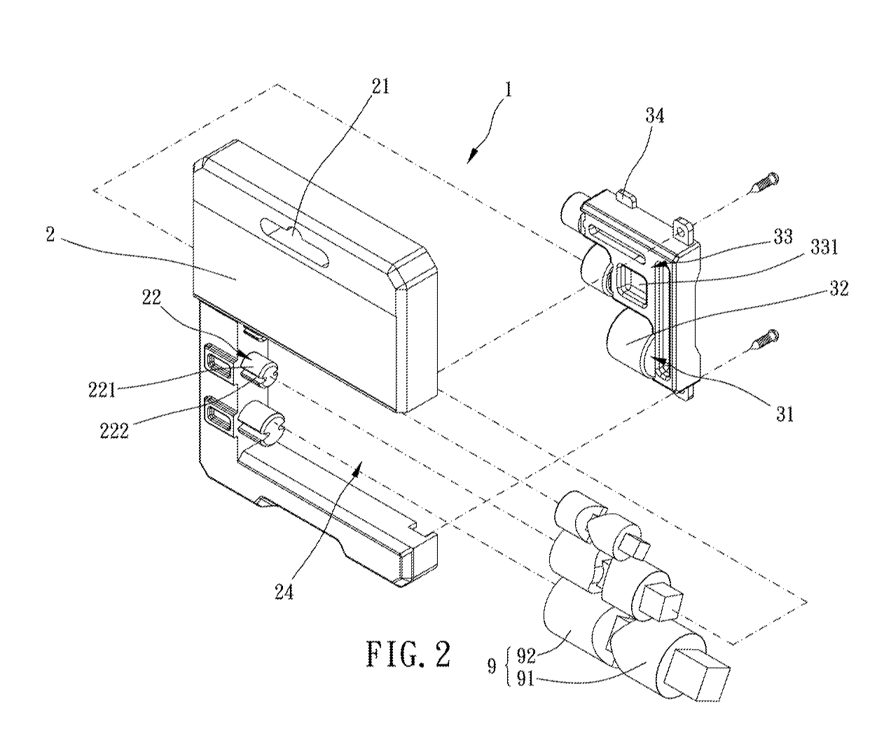

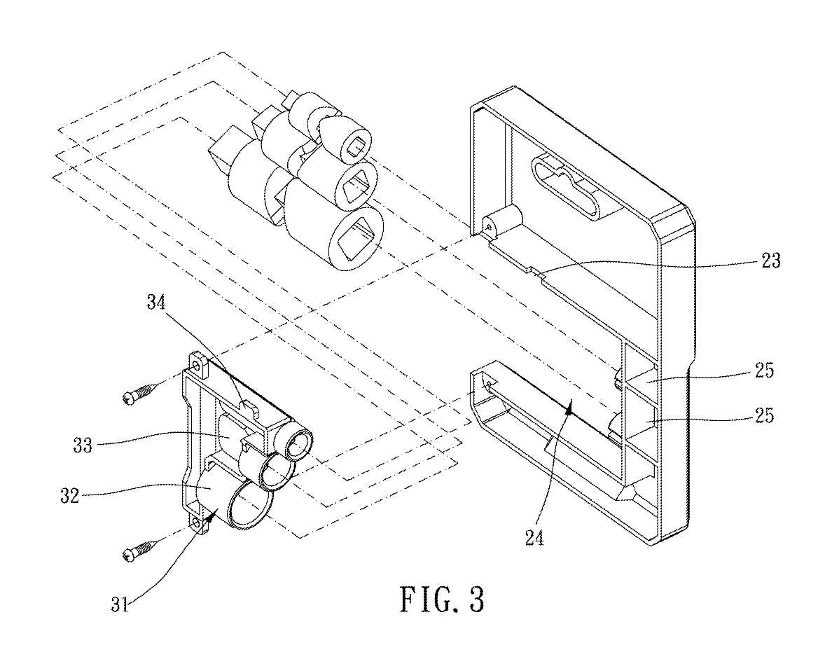

Please refer to FIGS. 1 to 3 for a preferred embodiment of the present invention. A tool holder 1 is provided for at least one universal joint 9 to be assembled thereto, and the universal joint 9 includes a plug 91 and a socket 92 which are movable relative to each other. In this embodiment, there are a plurality of universal joints 9, and the universal joints 9 are in different dimensions. The tool holder 1 includes a main body 2 and a positioning member 3.

The main body 2 includes a hanging portion 21 and an assembling portion 22, and the assembling portion 22 is protrudingly formed with at least one first engaging block 221. The positioning member 3 is assembled to the main body 2 and extends toward the assembling portion 22 to form at least one second engaging block 31 which is opposite to the at least one first engaging block 221.

The at least one first engaging block 221 and the at least one second engaging block 31 are for being fitted and engaged with the plug 91 and the socket 92 of the universal joint 9. Specifically, in this embodiment, a number of the at least one first engaging block 221 and a number of the at least one second engaging block 31 respectively correspond to a number of the universal joint 9, each said first engaging block 221 includes an insertion block 222 for being inserted into one said socket 92 or a tubular section 32 for one said plug 91 to be inserted thereinto, and each said second engaging block 31 includes a tubular section 32 for one said plug 91 to be inserted thereinto or an insertion block 222 for being inserted into one said socket 92. In this embodiment, each said first engaging block 221 is one said insertion block 222, and each said second engaging block 31 is one said tubular section 32. The insertion block 222 is inserted into the socket 92, and the plug 91 is inserted into the tubular section 32; therefore, movements of the plug 91 and the socket 92 of the universal joint 9 are restricted, and the plug 91 and the socket 92 may be even unmovable relative to each other. Hence, the socket 92 and the plug 91 can be prevented from being disengaged with the at least one first engaging block 221 and the at least one second engaging block 31, and the universal joint 9 cannot be disengaged with the main body 2.

More specifically, the positioning member 3 may further include an extension section 33 protruding toward the assembling portion 22, and the at least one said second engaging block 31 is disposed on the extension section 33 for the universal joint 9 which is shorter to be assembled thereto. In this embodiment, two said second engaging blocks 31 are disposed on the extension section 33, and the extension section 33 is stepped for the two universal joints 9 in different dimensions to be respectively engaged with the two second engaging blocks 31. Preferably, a side of the extension section 33 is formed with at least one material-saving recess 331. In this embodiment, there are a plurality of material-saving recesses 331; and with the material-saving recesses 331, the weight of the positioning member 3, and the cost of manufacturing the positioning member 3 is lower.

In this embodiment, the positioning member 3 is screwed to the main body 2 to prevent the positioning member 3 from being removed and prevent the universal joints 9 from being taken out. In other embodiments, the positioning member may be fastened to or engaged with the main body. In addition, in this embodiment, the positioning member 3 may further extend to form an abutting member 34, the main body 2 is formed with an abutted portion 23, and the abutting member 34 and the abutted portion 23 are fixedly engaged with each other so as to allow the positioning member 3 to be stably positioningly engaged with the main body 2. Specifically, the main body 2 is substantially C-shaped and further includes a receiving space 24 for the universal joints 9 to be received therein. The first engaging blocks 221 protrude into the receiving space 24, and the positioning member 3 bars an opening end of the receiving space 24. Preferably, the main body 2 may further include a plurality of hollow-out portions 25, and the hollow-out portions 25 are circumferentially arranged around the receiving space 24. With the hollow-out portions 25, the weight of the main body 2 is reduced, and the cost of manufacturing the main body 2 is lower.

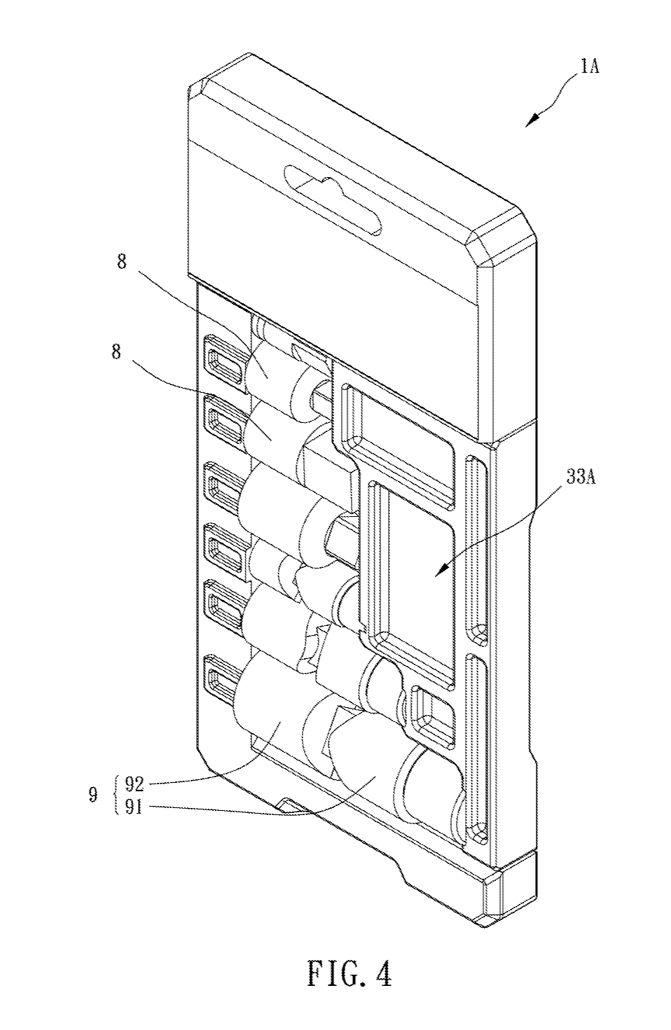

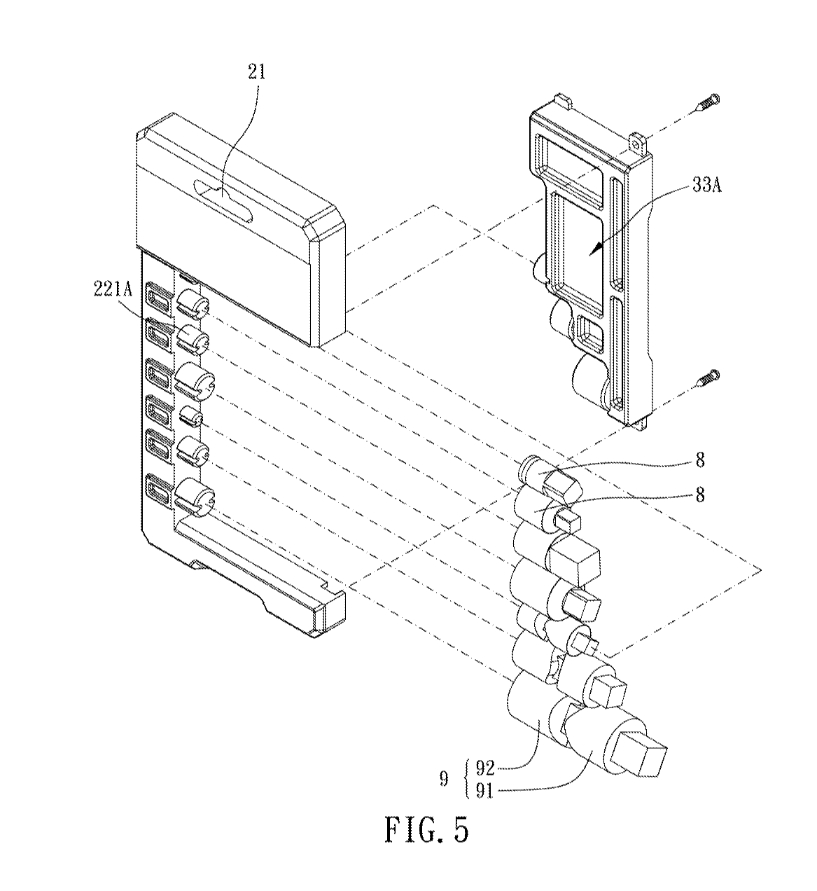

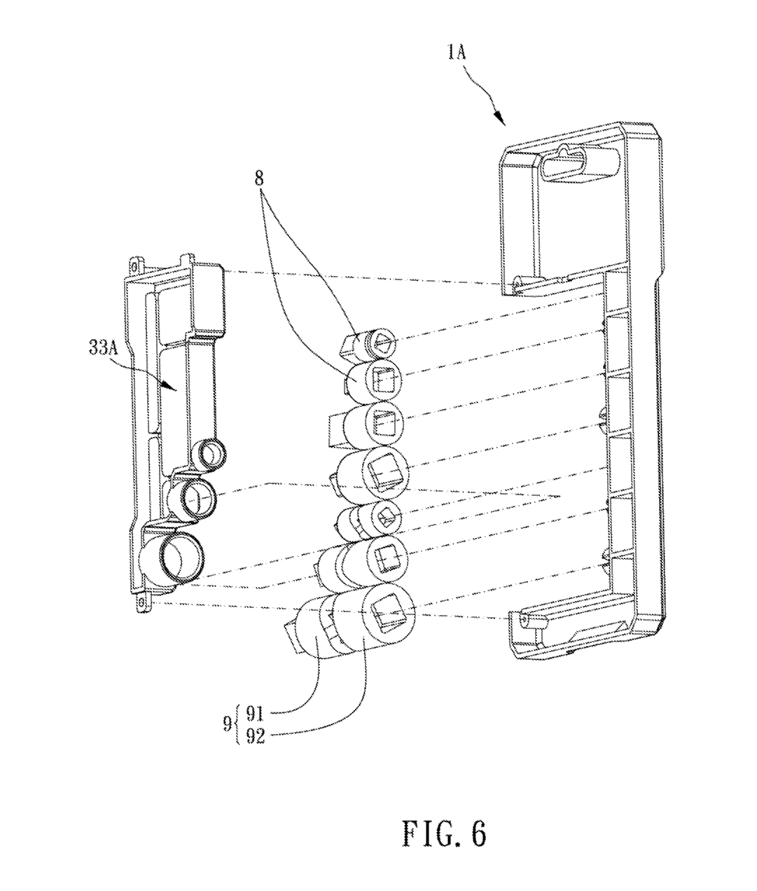

Please further refer to FIGS. 4 to 6 for another embodiment. A tool holder 1A further includes at least one first engaging block 221A, the at least one first engaging block 221A is for an end of at least one socket tool 8 to be inserted thereinto, and a lateral wall of the extension section 33A is for the other end of the at least one socket tool 8 to abut thereagainst. In this embodiment, a plurality of the first engaging blocks 221A are respectively for a plurality of the socket tools 8 to be inserted thereinto, and the other ends of the socket tools 8 abut against the extension section 33A to effectively prevent each said socket tool 8 from being disengaged with the first engaging block 221A. The tool holder 1A is provided for not only the universal joint 9 but also the socket tool 8 to be assembled thereto.

Given the above, in the tool holder of the present invention, the plug and the socket are respectively fitted and engaged with the first and second engaging blocks; therefore, when the plug and the socket of the universal joint move relative to each other, the plug and socket can be prevented from being disengaged, and the universal joint cannot be disengaged with the main body. In addition, the tool holder is provided for not only the universal joint but also the socket tool to be assembled thereto.

While we have shown and described various embodiments in accordance with the present invention, it should be clear to those skilled in the art that further embodiments may be made without departing from the scope of the present invention.

What is claimed is:

1. A tool holder, provided for at least one universal joint to be assembled thereto, the universal joint including a plug and a socket which are movable relative to each other, the tool holder including:
a main body, including a hanging portion and an assembling portion, the assembling portion protrudingly formed with at least one first engaging block;
a positioning member, assembled to the main body and extending toward the assembling portion to form at least one second engaging block which is opposite to the at least one first engaging block;
wherein the at least one first engaging block and the at least one second engaging block are provided for being fitted and engaged with the plug and the socket of the universal joint.

2. The tool holder of claim 1, wherein each said first engaging block includes an insertion block for being inserted into one said socket or a tubular section for one said plug to be inserted thereinto.

3. The tool holder of claim 1, wherein each said second engaging block includes a tubular section for one said plug to be inserted thereinto or an insertion block for being inserted into one said socket.

4. The tool holder of claim 1, wherein the positioning member further includes an extension section protruding toward the assembling portion, and at least one said second engaging block is disposed on the extension section.

5. The tool holder of claim 4, wherein the extension section is stepped, and a side of the extension section is formed with at least one material-saving recess.

6. The tool holder of claim 5, wherein at least one said first engaging block is for an end of at least one socket tool to be inserted thereinto, and a lateral wall of the extension section is for the other end of the at least one socket tool to abut thereagainst.

7. The tool holder of claim 1, wherein the positioning member is screwed to the main body.

8. The tool holder of claim 1, wherein the positioning member further extends to form an abutting member, the main body is formed with an abutted portion, and the abutting member and the abutted portion are fixedly engaged with each other.

9. The tool holder of claim 1, wherein the main body is substantially C-shaped and further includes a receiving space for the at least one universal joint to be received therein, the at least one first engaging block protrudes into the receiving space, and the positioning member bars an opening end of the receiving space.

10. The tool holder of claim 9, wherein the main body further includes a plurality of hollow-out portions, and the hollow-out portions are circumferentially arranged around the receiving space.
